(19) United States
(12) Patent Application Publication
(10) Pub. No.: US 2007/0268397 A1
(43) Pub. Date: Nov. 22, 2007

(54) Image pickup apparatus and image pickup control method

(75) Inventor: Shinichiro Udono, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 11/797,803

(22) Filed: May 8, 2007

(30) Foreign Application Priority Data
May 12, 2006 (JP) 2006-134302

(51) Int. Cl. H04N 5/235

(52) U.S. Cl. 348/362

(57) ABSTRACT

According to the present invention, after a user of the image pickup apparatus sets an image pickup asking mode at will, the user hands the image pickup apparatus to a person to ask to pickup an image. When the person inputs a record indication, an automatic exposure control and automatic focusing control is immediately performed to record an image data. That is, even when a person who is asked to pickup an image fully presses a release button to input a record indication with no knowledge about the apparatus, an appropriate exposure and focus is immediately set to record an image data, so that an appropriate image can be obtained without any special operation even when the person who is asked for image pickup does not know how to use the camera at all. This allows a user of the image pickup apparatus to lightly ask a person to pickup an image.

### BACKGROUND OF THE INVENTION

1. Field of the Invention

The present invention relates to an operation control of a camera for asking someone to pickup an image using the camera.

2. Description of the Related Art

Conventionally, technologies to explain an operation procedure of a camera in a simple and clear way have been devised. For example, according to Japanese Patent Application Laid-Open No. 2004-128820, a pressing down of a help key causes a section for manual data to be displayed on an LCD display section to explain how to use checkboxes. According to Japanese Patent Application Laid-Open No. 2004-165782, when a user is at a loss as to a next operation in picking up an image with a digital camera, the user may press a help button to display a screen of guidance list on the LCD, so that a cursor can be used to select and determine a desired item from the screen. This starts an operation of guidance. In the guidance, operation buttons are automatically pressed serially in accordance with the operation procedure, and an LED which is built-in each operation button is turned on to show a demonstration of how to use the camera.

### SUMMARY OF THE INVENTION

In picking up a group portrait or a commemorative picture during a trip, a user of a camera often asks other tourist or passerby to pick up the picture. However, in many cases, the person who is asked for the image pickup does not know the camera procedure and the images picked up by the person will be different from the one the user expects, or the person often refuses the request. Moreover, in abroad, a user usually cannot ask others to pickup an image due to language differences, or cannot explain how to use the camera after the request.

The present invention was made in view of the above problems, and one object of the present invention is to provide a camera which can be lightly operated by a person who is asked to pickup an image by using the camera.

The present invention relates to an image pickup apparatus, comprising: an image pickup element for receiving an incident light through an image pickup lens from an object and continuously converting the light into an image pickup signal to output; an image data converting section for converting the image pickup signal output from the image pickup element into an image data to output; a record indicating section for inputting a record indication of the image data; an exposure controlling section for controlling an exposure of the image pickup element in response to an acceptance of an input of the record indication at the record indicating section; a recording section for recording the image data of the image pickup signal output from the image pickup element in response to the exposure control by the exposure controlling section; and a display section for displaying at least the image data recorded in the recording section.

The image pickup apparatus according to the present invention further comprises: an image pickup asking section for accepting an input of information that a user asks a person to pickup an image; an image pickup asking mode setting section for setting an image pickup asking mode which is an appropriate operation mode for picking up an image by the person in response to the input of information that the user asks the person to pickup an image at the image pickup asking section; and an image pickup controlling section for immediately performing an automatic exposure control and automatic focusing control, in response to the acceptance of an input of the record indication at the record indicating section when the image pickup asking mode setting section sets the image pickup asking mode, and controlling the recording section to record the image data.

According to the present invention, after a user of the image pickup apparatus sets an image pickup asking mode at will, the user hands the image pickup apparatus to a person to ask to pickup an image. When the person inputs a record indication, an automatic exposure control and automatic focusing control is immediately performed to record an image data.

That is, even when a person who is asked to pickup an image fully presses a release button to input a record indication with no knowledge about the apparatus, an appropriate exposure and focus is immediately set to record an image data, so that an appropriate image can be obtained without any special operation even when the person who is asked for image pickup does not know how to use the camera at all. This allows a user of the image pickup apparatus to lightly ask a person to pickup an image.

In the present invention, it is preferable that the exposure controlling section controls the exposure of the image pickup element at least two times in series in response to a single record indication to the record indicating section, and further comprises: an amplifier for amplifying the image pickup signal from the image pickup element by an amplification factor which can be set as desired to output to the image data converting section; a flashing section for flashing a light for picking up an image; a flashing control section for controlling to switch the flashing of the flashing section between a non-flashing state and a flashing state, in accordance with the serial exposure controls of the image pickup element by the exposure controlling section in response to the single record indication to the record indicating section, and the image pickup controlling section may control the recording section to record the image data of the image pickup signal output from the image pickup element after the amplification factor of the amplifier is set to be a predetermined higher amplification factor in accordance with the non-flashing state, and the image data of the image pickup signal output from the image pickup element after the amplification factor of the amplifier is set to be a predetermined lower amplification factor in accordance with the flashing state.

Both of the image data which is obtained in a non-flash state and by a predetermined higher amplification factor in response to the single record indication and the image data which is obtained in a flash state and by a predetermined lower amplification factor can be recorded. The person who is asked to pickup an image can pickup an image without a possibility to fail in the judgment about the use of a flash or a high sensitivity at a low light situation, thereby an appropriate image can be obtained even at a low light situation.

The image pickup apparatus may further comprise a face detecting section for detecting a face area of an object based on the image data output from the image data converting section, so that, when the image pickup asking mode setting section sets an image pickup asking mode, the image pickup controlling section can immediately perform an automatic exposure control and automatic focusing control for the face area detected by the face detecting section.

Since an automatic exposure control and automatic focusing control is performed for the detected face area, even if the person who is asked to pickup an image does not know how to use the apparatus at all, defocusing or wrong exposure can be prevented without any special operation, which enables an appropriate image to be achieved.

The image pickup apparatus may further comprise a video image generating section for generating a video signal of a help screen which describes an operation procedure to pickup an image and outputting the video signal to the display section, so that, when the image pickup asking mode setting section sets an image pickup asking mode, the image pickup controlling section can control the video image generating section to generate the help screen.

The above described configuration facilitates an understanding of the operation procedure by a person who is asked to pickup image by seeing the help screen of the display section, without an explanation of the operation procedure of the image pickup apparatus by a user.

The image pickup apparatus may further comprise a language selecting section for selecting a desired language from the help screen, so that the image pickup controlling section controls the video image generating section to generate a help screen which describes an operation procedure for image pickup in the desired language selected in the language selecting section.

This allows the operation procedure to be described in the language which the person who is asked to pickup an image speaks.

The language selecting section may be configured to select a desired language in response to an input operation using an external device.

This allows a user or a person who is asked to pickup an image to select a desired language for the operation procedure.

The image pickup apparatus may further comprise a position acquiring section for receiving information on a current position to acquire the current position, so that the language selecting section can select a language corresponding to the current position acquired by the position acquiring section as the desired language.

This enables the operation procedure to be displayed in the language corresponding to the current position of the image pickup apparatus, that is, a local language, without a selection of a language by a user.

The image pickup asking section accepts an input of the completion of the request for image pickup, and the image pickup asking mode setting section cancels the image pickup asking mode in response to the input of the completion of the request for image pickup to the image pickup asking section, and when the image pickup asking mode setting section cancels the image pickup asking mode, the image pickup controlling section may cause the image pickup apparatus to return to the operating state in which the apparatus was before the image pickup asking mode setting section sets the image pickup asking mode.

This eliminates an operation to return the apparatus to the prior operating state by a user after the completion of the request for image pickup.

An image pickup control method according to the present invention comprises the steps of: accepting an input of information that a user asks a person to pickup an image; setting an image pickup asking mode which is an appropriate operation mode for picking up an image by the person in response to the input of information that the user asks the person to pick up an image; when the image pickup asking mode is set, in response to the acceptance of an input of a record indication at the record indicating section, immediately performing an automatic exposure control and automatic focusing control, and controlling the recording section to record the image data.

According to the present invention, when a user of the image pickup apparatus sets an image pickup asking mode at will and hands the image pickup apparatus to a person to ask to pickup an image, after the person inputs a record indication, an automatic exposure control and automatic focusing control is immediately performed, and an image data is recorded.

That is, when the person who is asked to pickup an image inputs a record indication as he/she is told, an appropriate exposure and focus is immediately set to record an image data, thereby even if the person who is asked to pickup an image does not know how to use the apparatus at all, an appropriate image can be acquired without any special operation. This allows a user of the image pickup apparatus to lightly ask a person to pickup an image.

### BRIEF DESCRIPTION OF THE DRAWINGS

FIG. 1 is a front view showing a digital camera;

FIG. 2 is a back view showing a digital camera;

FIG. 3 is a block diagram showing a digital camera according to first to fourth embodiments;

FIG. 4 is a top view showing a mode dial;

FIG. 5 is a flowchart showing a flow of an image pickup process according to a first embodiment;

FIG. 6 is a flowchart showing a flow of an image pickup process according to a second embodiment;

FIG. 7 is a flowchart showing a flow of an image pickup process according to a third embodiment;

FIG. 8 is a flowchart showing a flow of an image pickup process according to a fourth embodiment;

FIG. 9 is a view showing an example of help screen;

FIG. 10 is a block diagram showing a digital camera according to a fifth embodiment;

FIG. 11 is a flowchart showing a flow of an image pickup process according to the fifth embodiment;

FIG. 12 is a view showing an example of a “Language Selection” menu;

FIG. 13 is a view showing an example of a “Manual Language Selection” menu; and

FIG. 14 is a view showing an example of a help screen in which a desired language is English.

### DETAILED DESCRIPTION OF THE PREFERRED EMBODIMENTS

Now, preferred embodiment of the present invention will be explained below with reference the drawings.

### First Embodiment

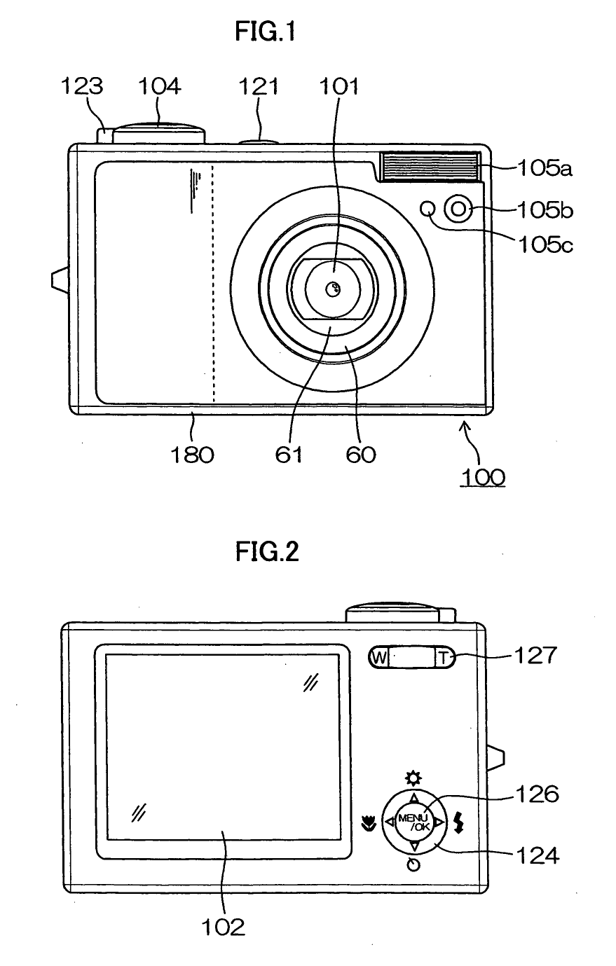

FIG. 1 is a front view showing a digital camera (hereinafter, simply referred to as camera) 100 according to a preferred embodiment of the present invention.

The camera 100 has a lens barrel 60 on the front surface thereof, and the lens barrel 60 is provided with a built-in photographing lens 101 including a zoom lens 101a and a focusing lens 101b, so that a movement of the zoom lens 101a in the direction of the optical axis enables a focal length adjustment, and also a movement of the focusing lens 101b in the direction of the optical axis enables a focus adjustment.

The lens barrel 60 advances and retracts between a wide angle end for the shortest focal length and a telephoto end for the longest focal length, both ends being set in advance, so as to be projected out of and housed in a camera body 180. In FIG. 1, the lens barrel 60 is retracted in the camera body 180.

The camera 100 is also provided with a lens cover 61 for protecting the photographing lens 101 by covering the front surface of the photographing lens 101 to shield it from the outside while the camera 100 is not operated for photographing, and for exposing the photographing lens 101 to the outside for image pickup.

The lens cover 61 is configured with an openable and closable mechanism for covering the front surface of the photographing lens 101 at its open position, and exposing the front surface of the photographing lens 101 to the outside at its closed position. The lens cover 61 is interlocked to a power button 121 to be opened/closed. In FIG. 1, the lens cover 61 is opened.

The camera 100 has a mode dial 123 provided with a central release button 104, and a power button 121 on the top surface thereof, and has an electronic flash unit 105a, an AF auxiliary light lamp 105b, a self-timer lamp 105c and the like on the front surface thereof.

FIG. 2 is a back view showing the camera 100. The camera 100 has a zoom switch 127 on the rear surface thereof. A continuous pressing of a telephoto (T) side of the zoom switch 127 causes the lens barrel 60 to be projected toward the telephoto side, and a continuous pressing of the other side (W) of the zoom switch 127 causes the lens barrel 60 to move toward the wide angle side.

The camera 100 also has an image display LCD 102, a crosskey 124, an information position specifying key 126 and the like on the rear surface thereof. The crosskey 124 is an operation system to set a display brightness control, a self-timer, a macro photography, and a flash photography at the top, bottom, left, and right portions thereof respectively. As explained below, a pressing of the bottom key of the crosskey 124 sets a self photographing mode in which a main CPU 20 causes a CCD 132 to operate a shutter operation after a clocking of the self-timer circuit 83 is completed.

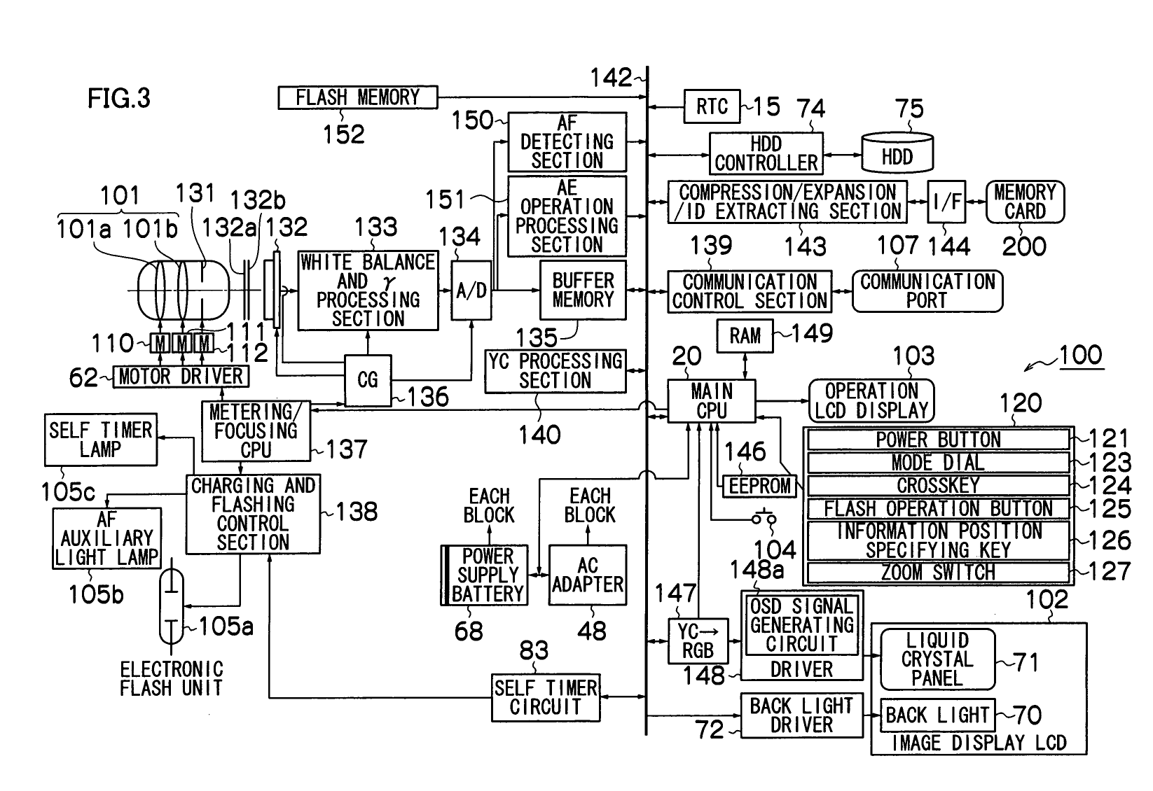

FIG. 3 is a block diagram of the camera 100 according to the first embodiment. The camera 100 is provided with an operating section 120 for various operations associated with a use of the camera 100 by a user. The operating section 120 includes a power button 121 for supplying power to operate the camera 100, a mode dial 123 for selecting an auto photography, a manual photography or the like, a crosskey 124 for setting or selecting different menu or zooming, a flash operation button 125, and an information position specifying key 126 for implementing or canceling the menu selected by the crosskey 124.

The camera 100 is also provided with an image display LCD 102 for displaying a photographed image, reproduced image or the like, and an operation LCD display 103 for assisting the operations.

The camera 100 includes a release button 104. A pressing of the release button 104 informs a main CPU 20 of a start of photographing. The camera 100 is switchable between a photographing mode and a reproducing mode by using a predetermined menu screen. The camera 100 is also provided with an AF auxiliary light lamp 105b having light emitting diodes (LED) for emitting a spot light to an object in a contrast AF mode, and a flash operation device having an electronic flash unit 105a for flashing light.

The camera 100 is also provided with a photographing lens 101, an aperture 131, and a CCD image sensor 132 (hereinafter, simply referred to as CCD 132) which is an image pickup element for converting the object image which is formed through the photographing lens 101 and the aperture 131 into an analog image signal. The CCD 132 generates an image signal by accumulating the charges generated by the object light incident on the CCD 132 for a variable charge storage time (exposure time). The CCD 132 sequentially outputs an image signal for each frame at a timing synchronized with the vertical synchronizing signal VD which is output from a CG section 136.

When the used image pickup element is the CCD 132, an optical lowpass filter 132a is provided thereto which removes unnecessary high frequency components in an incident light in order to prevent generation of a color error signal, moire fringe or the like. Also, an infrared cut filter 132b is provided for absorbing or reflecting the infrared rays of the incident light to correct the sensitivity characteristics inherent to the CCD 132 which has a high sensitivity to a longer wavelength range. The optical lowpass filter 132a and infrared cut filter 132b may be arranged in any manner without being limited to any particular aspect.

The camera 100 is also provided with a white balance and γ processing section 133 which includes an amplifier where amplification factor is variable, for adjusting the white balance of the object image represented by the analog image signal from the CCD 132, controlling the slope (γ) of the straight line in the gradient characteristics of the object image, and amplifying the analog image signal.

The camera 100 is also provided with an A/D converting section 134 for A/D converting the analog signal from the white balance and γ processing section 133 into digital R, G, and B image data, and a buffer memory 135 for storing the R, G, and B image data from the A/D converting section 134.

The R, G, and B image data obtained by the A/D converting section 134 is also input to an AF detecting section 150. The AF detecting section 150 integrates and averages the R, G, and B image data on the basis of a predetermined divided area in one screen and a color component of the screen, and further calculates the integral average values Ir, Ig, and Ib of the R, G, and B image data for the entire areas for each frame. The integral average values Ir, Ig, and Ib are the received amounts of visible light in R, G, and B, respectively.

However, the received amounts Ir, Ig, and Ib of visible light in R, G, and B can also be detected by an optical sensor (not shown) other than CCD 132 which has sensitivities for each visible light in R, G, B.

The camera 100 is also provided with the CG (clock generator) section 136, a CPU for metering/focusing CPU 137 a charging and flashing control section 138, a communication control section 139, a YC processing section 140, and a power supply battery 68.

The CG section 136 outputs vertical synchronizing signals VD for driving the CCD sensor 132, driving signals including a high speed output pulse P, control signals for controlling the white balance and γ processing section 133 and the A/D converting section 134, and control signals for controlling the communication control section 139. The CG section 136 receives control signals which are input by a metering/focusing CPU 137.

The metering/focusing CPU 137 controls a zoom motor 110, a focus motor 111, and an aperture motor for aperture adjustment 112 to drive the zoom lens 101a, focusing lens 101b, aperture 131 respectively, so that the distance to the object is calculated (focusing), and the CG section 136 and the charging and flashing control section 138 are controlled. The driving of the zoom motor 110, the focus motor 111, and the aperture motor 112 is controlled by a motor driver 62, control command for motor driver 62 is sent from the metering/focusing CPU 137 or the main CPU 20.

The driving source of the zoom lens 101a, the focusing lens 101b, the aperture 131, and the AF auxiliary light lamp 105 is not necessarily limited to various motors such as the zoom motor 110, the focus motor 111, and the aperture motor 112, and may be an actuator for example.

The metering/focusing CPU 137 measures the brightness of the object (calculation of EV value) based on the image data (through image) periodically obtained (every 1/30 seconds to 1/60 seconds) by the CCD 132 when the release button 104 is half pressed (S1 is on).

That is, an AE operation processing section 151 integrates the R, G, and B image signals output from the A/D converting section 134, and provides the resultant integrated value to the metering/focusing CPU 137. The metering/focusing CPU 137 detects an average brightness of the object (object luminance) based on the integrated value input from the AE operation processing section 151, and calculates an exposure value (EV value) which is appropriate to photographing.

Then, the metering/focusing CPU 137 determines an exposure value including an aperture value (F value) of the aperture 131 and an electronic shutter (shutter speed) of the CCD 132 based on the obtained EV value and according to a predetermined program diagram (AE operation).

A full pressing of the release button 104 (S2 is on) causes the metering/focusing CPU 137 to drive the aperture 131 based on the determined aperture value, control the diameter of the aperture 131, and control the charge storage time at the CCD 132 via the CG 136 based on the determined shutter speed.

The AE operation includes aperture priority AE, shutter speed priority AE, program AE, and the like, and either operation is controlled to pickup image with a proper exposure, by measuring an object luminance and photographing with an exposure value, that is, a combination of an aperture value and a shutter speed, which is determined based on the measured value of the object luminance. This achieves an elimination of the troublesome process to determine an exposure.

The AF detecting section 150 extracts an image data, which corresponds to the detecting range selected by the metering/focusing CPU 137, from the A/D converting section 134. A focal position is detected using the characteristics of a high frequency component in the image data which has the maximum amplitude at the focused point. The AF detecting section 150 integrates the high frequency components in the extracted image data for one field so as to calculate an amplitude value. The AF detecting section 150 serially performs the calculation of the amplitude value while the metering/focusing CPU 137 controls the focus motor 111 to drive the zoom lens 101a to move within the movable range, that is between an infinite side (INF point) and a near side end (NEAR point), and sends the detected value to the metering/focusing CPU 137 when the maximum amplitude is detected.

The metering/focusing CPU 137, after obtaining the detected value, issues a command to the focus motor 111 to cause the focusing lens 101b to move to the focused position corresponding to the detected value. The focus motor 111 causes the focusing lens 101b to move to the focused position, in response to the command issued by the metering/focusing CPU 137 (AF operation).

The metering/focusing CPU 137 is connected to the release button 104 by way of the communication with the main CPU 20, and when a user presses the release button 104 halfway, the detection of a focused position is performed. The metering/focusing CPU 137 is connected to the zoom motor 110, so that when the main CPU 20 acquires a command for a zooming in the TELE direction or WIDE direction by the zoom switch 127 from a user, a driving of the zoom motor 110 allows the zoom lens 101a to move between the WIDE end and the TELE end.

The charging and flashing control section 138 charges a flashing capacitor (not shown) for flashing the electronic flash unit 105a when powered by a power battery 68, and controls the flashing of the electronic flash unit 105a.

The charging and flashing control section 138 controls the power supply to the self-timer lamp (tally lamp) 105c and the AF auxiliary light lamp 105b so that a desired light amount can be obtained at a desired timing, in response to the start of the charge of the power battery 68 and the receipt of various signals including the half pressed/fully pressed operation signal of the release button 104 and the signals showing the light amount and flashing timing from the main CPU 20 and the metering/focusing CPU 137.

The self-timer lamp 105c may use LEDs and the LEDs may be common to those used in the AF auxiliary light lamp 105b.

The main CPU 20 is connected to the self-timer circuit 83. When a self photographing mode is set, the main CPU 20 performs a clocking based on a fully pressed signal of the release button 104. During the clocking, the main CPU 20 causes the self-timer lamp 105c to blink with the blinking speed being increased as the remained time decreases, through the metering/focusing CPU 137. The self-timer circuit 83 inputs a clocking completion signal to the main CPU 20 upon the completion of the clocking. Then the main CPU 20 causes the CCD 132 to perform a shutter operation based on the clocking completion signal.

The communication control section 139 is provided with a communication port 107. The communication control section 139 functions to perform a data communication with the external apparatus by outputting an image signal of the object photographed by the camera 100 to the external apparatus such as a personal computer having a USB terminal and allowing such an external apparatus to input an image signal to the camera 100. The camera 100 has a function which is mimic to the switching function of a standard camera for photographing onto a roll of a film to switch between ISO film speeds 80, 100, 200, 400, 1600, and when a film speed of ISO 400 or more is selected, the amplification factor of an amplifier included in the white balance and 7 processing section 133 switches to a high sensitivity mode in which the amplification factor is set to be higher than a predetermined amplification factor. The communication control section 139 disconnects the communication with an external apparatus during the photographing in a high sensitivity mode.

The camera 100 is further provided with a compressing/expanding/ID extracting section 143 and an I/F section 144. The compressing/expanding/ID extracting section 143 reads out an image data stored in the buffer memory 135 through a bus line 142 and compresses the image data, which is stored in the memory card 200 via the I/F section 144. The compressing/expanding/ID extracting section 143 also extracts an identification number (ID) unique to the memory card 200 when it reads out an image data stored in the memory card 200, so that the compressing/expanding/ID extracting section 143 reads out the image data stored in the memory card 200, and expands and stores it in the buffer memory 135.

A Y/C signal stored in the buffer memory 135 is compressed by the compressing/expanding/ID extracting section 143 according to a predetermined format, and then is recorded to a removable medium such as the memory card 200 or built-in high-capacity storage media such as a hard disk (HDD) 75 via the I/F section 144 in a predetermined format (for example, Exif (Exchangeable Image File Format) file). A recording of a data to the hard disk (HDD) 75 or a reading of a data from the hard disk (HDD) 75 is controlled by the hard disk controller 74 in response to a command issued by the main CPU 20.

The camera 100 is also provided with the main CPU 20, an EEPROM 146, a YC/RGB conversion section 147, and a display driver 148. The main CPU 20 provides overall controls of the camera 100. The EEPROM 146 stores individual data and programs unique to the camera 100. The YC/RGB conversion section 147 converts a color video signal YC generated at the YC processing section 140 into a three-color RGB signal, and outputs the converted signal to the image display LCD 102 via the display driver 148.

The camera 100 has an AC adapter 48 and a power battery 68 removably attached thereto for an electric power supply from an AC power source. The power battery 68 may be a rechargeable secondary battery such as a Nickel-Cadmium battery, a nickel hydrogen battery, or a lithium ion battery. Alternatively, the power battery 68 may be a single use primary battery such as a lithium battery or an alkaline battery. The power battery 68 is mounted in a battery housing chamber (not shown) to be electrically connected to each circuit of the camera 100.

When the AC adapter 48 is mounted to the camera 100 for an electric power supply from the AC power source to the camera 100 via the AC adapter 48, even if the power battery 68 is mounted to the battery housing chamber, the electric power output from the AC adapter 48 has the priority to be supplied to each section of the camera 100 as a driving electric power. When the AC adapter 48 is not mounted to the camera 100 and the power battery 68 is mounted to the battery housing chamber, the electric power output from the power battery 68 is supplied to each section of the camera 100 as a driving electric power.

Although not shown, the camera 100 is provided with a backup battery other than the power battery 68 which is mounted to the battery housing chamber. The built-in backup battery may be a dedicated secondary battery which is charged by the power battery 68, for example. The backup battery supplies power to the basic functions of the camera 100 when the power battery 68 is not mounted to the battery housing chamber for its replacement or removal.

That is, a stoppage of power supply from the power battery 68 or the AC adapter 48 causes a switching circuit (not shown) to connect the backup battery to a RTC 15 for a power supply to the circuits. This enables a continuous power supply to the basic functions including the RTC 15 until the end of the useful life of the backup battery 29.

The RTC (Real Time Clock) 15 is a dedicated chip for clocking, and remains in continuous operation with the electric power supply from the backup battery even while a power supply from the power battery 68 or the AC adapter 48 is stopped.

The image display LCD 102 is provided with a back light 70 which illuminates a transmissive or semi-transmissive liquid crystal panel 71 from its rear surface side, and in a power saving mode, the main CPU 20 controls the brightness (luminance) of the back light 70 via a backlight driver 72, so that the power consumption by the back light 70 can be reduced. The power saving mode can be turned on/off when the information position specifying key 126 of the operation section 120 is pressed to cause the image display LCD 102 to display a menu screen and a predetermined operation is executed on the menu screen.

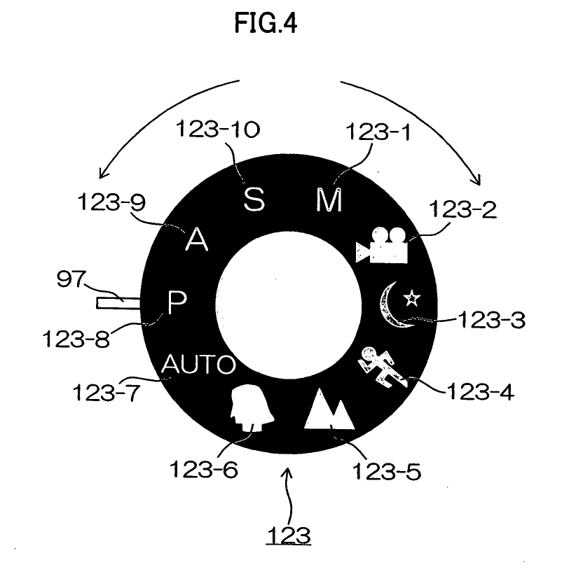

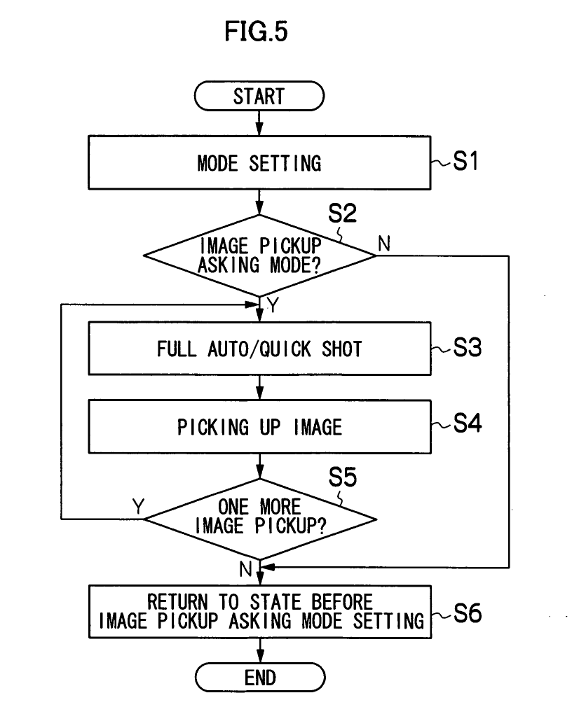

FIG. 4 is a top view of the mode dial 123. The mode dial 123 is configured with a rotary dial switch. The mode dial 123 is printed with icons which provide an intuitive illustration for an image pickup scene respectively. The mode dial 123 is rotatable in the direction shown by an arrow of FIG. 4 (clockwise or counter-clockwise), so that a person who picks up an image can select an image pickup mode by rotating the mode dial 123 to a position where a suitable icon for the image pickup scene is aligned with a alignment mark 97.

The image pickup modes include for example a static image pickup mode for picking up static images, and a dynamic image pickup mode for picking up dynamic images, and the image pickup mode for static images further includes an auto mode for automatically setting image conditions such as shutter speed and aperture value, a manual mode for manually setting the image conditions, and various image pickup modes for automatically setting image conditions such as suitable shutter speed, aperture value, exposure value and white balance, depending on various image pickup scenes like an image pickup of people, an image pickup of landscape, an image pickup of sports, an image pickup of night view (people mode, portrait image pickup mode, landscape mode, sports mode, and night view mode).

In FIG. 4, an icon 123-1 corresponds to the manual mode in which a shutter speed and an aperture value can be set as desired. An icon 123-2 corresponds to the dynamic image mode in which dynamic images can be picked up. An icon 123-3 corresponds to the night view mode suitable to pick up an image of night view. An icon 123-4 corresponds to the sports mode suitable to pick up an image with an object which moves quickly such as a sports scene. An icon 123-5 corresponds to the landscape mode suitable to pick up an image of landscape. An icon 123-6 corresponds to the portrait mode suitable to pick up an image of people. An icon 123-7 corresponds to the auto mode in which various images can be picked up depending on image pickup scenes. An icon 123-8 corresponds to a program auto mode in which image pickup conditions other than shutter speed/aperture can be set. An icon 123-9 corresponds to an aperture priority auto mode in which an aperture value can be set. An icon 123-10 corresponds to a shutter priority auto mode in which a shutter speed can be set.

An alignment of each of the icons 123-1 to 123-10 for each image pickup mode with the alignment mark 97 achieves the setting of the image pickup mode. Upon the setting of an image pickup mode, an image pickup is performed based on the image pickup conditions which are defined in advance for the image pickup mode, and simultaneously an image process for the mode is performed.

For example, in the portrait image pickup mode, the aperture 131 is set to an open side in order to highlight a person who is the main object and blur the background, and in the image process, a color correction is intensively performed so that the skin color is clearly pictured. Also, in the landscape mode, a color saturation is enhanced, and also a contrast is increased and a sharpness is increased for distinct colors. In a macro image pickup mode, since it can be assumed that images of flowers and plants are picked up in many cases, a process to enhance a color saturation is performed. The night view mode is used to pick up an image in a low light situation such as a night view without flashing the electronic flash unit 105a. In the night view mode, a shutter speed of the CCD 132 is set for a long time exposure over 1/60 seconds (long shutter mode).

However, the image pickup modes do not necessarily have to be set by using the mode dial 123. For example, the image pickup modes may be configured to be selected as desired from the image pickup mode menu displayed on the image display LCD 102 by an operation of the crosskey 124 and the information position specifying key 126. Alternatively, an operation device for setting/canceling a single image pickup mode (a macro image pickup button, a self-timer button, a flash button, and the like) (not shown) may be provided so that the image pickup modes can be set by using the operation device.

The image pickup modes are not limited to those listed above, and other modes for desired image pickup scenes may be provided.

Now, with reference to a flowchart of FIG. 5, a flow of an image pickup process according to a first embodiment will be explained.

At S1, by an operation of GUI generated by the OSD signal generating circuit 148a or the mode dial 123, in response to the acceptance of the setting of an image pickup mode or an image reproducing mode of the camera 100, an operating state is activated as a user desires.

At S2, the main CPU 20 determines if the image pickup asking mode is set or not by using an “You Can Ask Image Pickup” button on the GUI generated by the OSD signal generating circuit 148a or the operating section 120. When the image pickup asking mode is set, the process goes to S3. If the main CPU 20 determines that a mode other than the image pickup asking mode is set by the image pickup mode (for example, a people mode), an operation for the set operation mode is performed.

At S3, the main CPU 20 stops the operation at S1, and starts to display a through image to the LCD 102, and also performs an image pickup operation corresponding to the image pickup asking mode. That is, the main CPU 20 immediately performs an AE operation and AF operation (full auto mode) in response to the fully pressed (or half pressed) release button 104, and controls the focus motor 111 based on the computed results and immediately causes the focusing lens 101b to move to a resulted focal point and controls the motor for aperture 112 to immediately drive the aperture 131 (quick shot mode).

At S4, upon the completion of the immediate adjustment of the focus and aperture in response to the fully pressed (or half pressed) release button 104, the main CPU 20 immediately controls the shutter operation of the CCD 132 to acquire an image data for recording.

At S5, the main CPU 20 accepts an input which indicates if the image pickup is repeated once more or not from the “One More Image Pickup?” button on the GUI generated by the OSD signal generating circuit 148a or the mode dial 123. When an indication for the repetition is input, the process goes back to S3. When the indication is not input, the process goes to S6.

At S6, the main CPU 20 cancels the image pickup asking mode, and then the apparatus returns to the operating state in which the apparatus was just before the setting of the image pickup asking mode, that is, the operating state at S1. For example, the apparatus returns to the operating state for resetting the image pickup conditions for the image pickup mode set at S1, or to an image reproducing mode in which the apparatus was just before this image pickup process is started.

According to the above described processes, when an owner of the camera wants to ask a person to pickup an image of himself/herself, the owner only has to set an image pickup asking mode and hands the camera to the person, which allows the owner to lightly ask the person for an image pickup. Also, the asked person only has to press down the release button 104 (full press or half press), which causes an automatic focus and exposure adjustment to be immediately performed to record an image. This eliminates every troublesome setting while an image pickup can be easily achieved by an appropriate focusing and exposure, even if the person who is asked for an image pickup does not know how to use the camera well.

If the owner is not satisfied with the obtained image, since another image pickup process can be selected at S5 so that the owner can ask for another image pickup, the asked person does not have to pickup a satisfactory image by a single press-down operation of the release button 104. When the person is asked again for another image pickup, the person only repeats the press-down operation of the release button 104, thereby another image can be easily picked up, and the person can lightly accept the request for another image pickup.

Once a satisfactory image is obtained and another image pickup process is not selected at S5, the apparatus automatically returns to the image pickup mode before the image pickup asking mode setting, which eliminates an operation to make the apparatus return to the prior setting state by a user.

### Second Embodiment

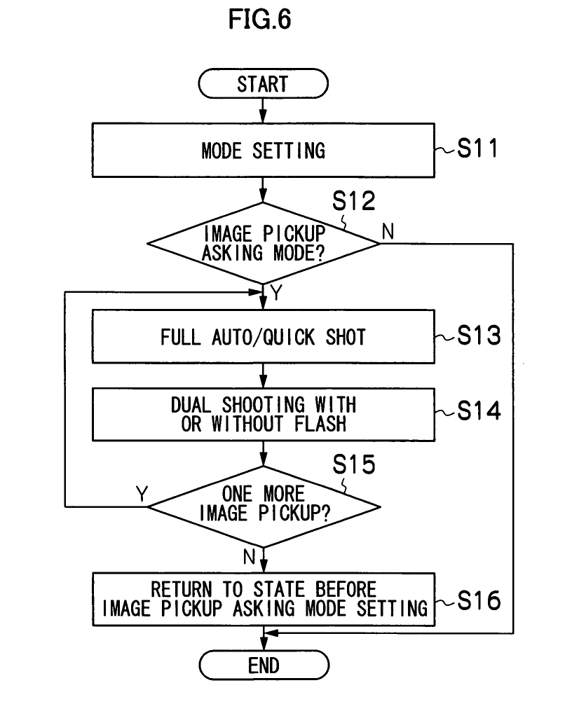

FIG. 6 is a flowchart showing a flow of an image pickup process according to a second embodiment.

S11 to S13 and S15 to S16 are similar to S1 to S3 and S5 to S6, respectively.

At S14, in response to a single fully pressing (or half pressing) operation of the release button 104, an amplification factor of the white balance and γ processing section 133 is set to be a predetermined higher factor (for example, at ISO 1600), and then a shutter operation is performed by the CCD 132 without flashing the electronic flash unit 105a, to acquire an image. Right after the image acquisition (for example, about 0.45 second later), an amplification factor of the white balance and γ processing section 133 is set to be a predetermined lower factor (for example, ISO 64), and a shutter operation is performed with the electronic flash unit 105a being flashed, to acquire an image.

In this way, a single pressing (fully or half pressing) operation of the release button 104 causes two operations to be performed for acquiring two shots of images which are taken without flashing strobe light at a high sensitivity, and with flashing strobe light at a low sensitivity, respectively. The acquired two images are recorded in the memory card 200.

According to the operation, when a person who is asked for an image pickup only presses the release button 104 once (fully or halfway), an exposure and a focusing are automatically adjusted, and two shots of images are taken without flashing strobe light at a high sensitivity, and with flashing strobe light at a low sensitivity, respectively. This provides an appropriate image, without the necessity to determine or select which is more appropriate for a low light situation, an image pickup with a strobe light or an image pickup at high sensitivity.

### Third Embodiment

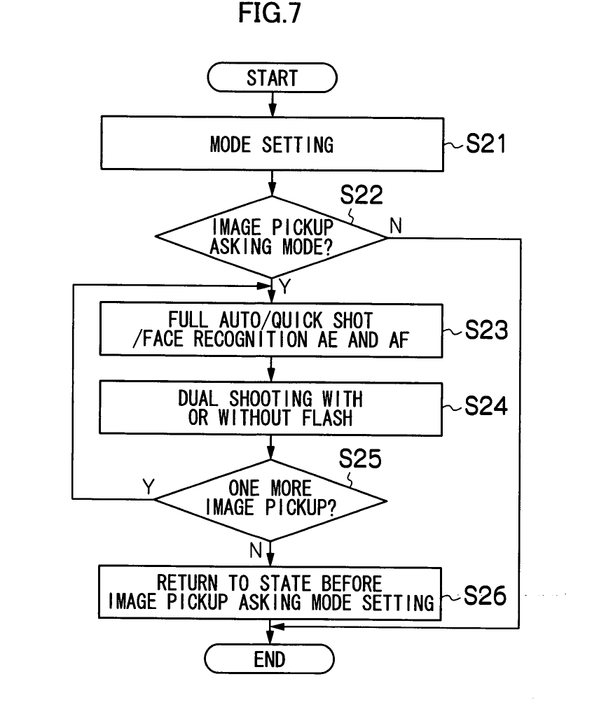

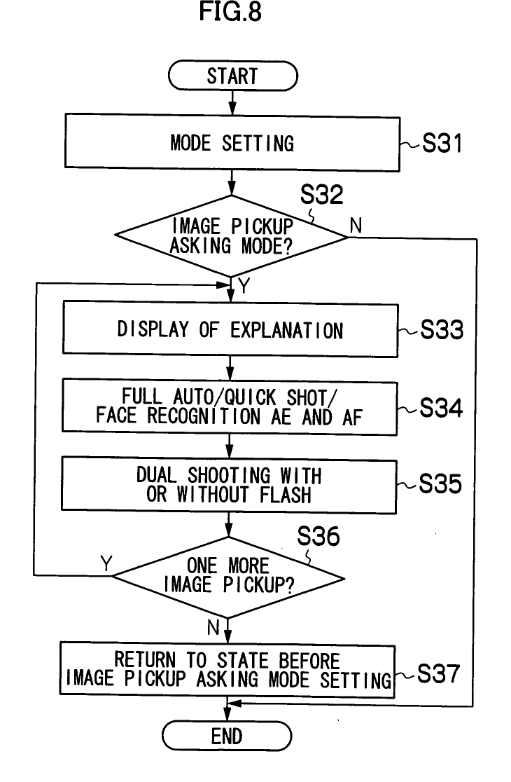

FIG. 7 is a flowchart showing a flow of an image pickup process according to a third embodiment.

S21, S22 and S24 to S26 are similar to S11, S12 and S14 to S16, respectively.

At S23, the CPU 20 recognizes a face of a person in the through image in response to the fully pressed (half pressed) release button 104. Upon the recognition of the face, the CPU 20 performs an AE operation and AF operation on the recognized face (face recognition AE and AF). And then based on the computed results by the face recognition AE and AF, the CPU 20 immediately controls the focus motor 111 to cause the focusing lens 101b to move to a focal point, and also controls the motor for aperture 112 to immediately drive the aperture 131.

The face recognition by the CPU 20 may be performed by using the technology disclosed in Japanese Patent Application Laid-Open No. 9-101579, entitled “Face Area Extraction Method And Copy Condition Determining Method” filed by the applicant of the present invention, for example. In the technology, it is determined if a color tone of each pixel in an photographed image is within a skin color range or not so that a skin color region and a non-skin color region are defined in the image, and also an edge in the image is detected so that every point of the image is categorized into an edge part or a non-edge part. Then, a region which locates in the skin color region, is consisted of the pixels categorized as the non-edge part, and is surrounded by the pixels determined to be the edge part is extracted as a face candidate region, and then it is determined if the extracted face candidate region corresponds to the face of the person or not, thereby a region is recognized as a face area based on the determined result. Alternatively, a face area may be recognized by using the method described in Japanese Patent Application Laid-Open No. 2003-209683 or Japanese Patent Application Laid-Open No. 2002-199221.

According to the operation, when a person who is asked for an image pickup only presses the release button 104 once (fully or halfway), two images are picked up in a dual shooting mode with or without a flash after an automatic focusing onto a face of an object person, thereby an image pickup with a focal point on an object person can be easily performed.

### Fourth Embodiment

FIG. 8 is a flowchart showing a flow of an image pickup process according to a fourth embodiment.

S31 to S32 and S34 to S37 are similar to S21 to S22 and S23 to S26, respectively.

At S33, the CPU 20 indicates the OSD signal generating circuit 148a to generate a video signal of a help screen which includes a document, an image, or other visual object that describes a method for using the camera 100, for a person who accepts the request for an image pickup (that is, photographer). In response to the indication, the OSD signal generating circuit 148a generates a help screen and supplies it to the LCD 102.

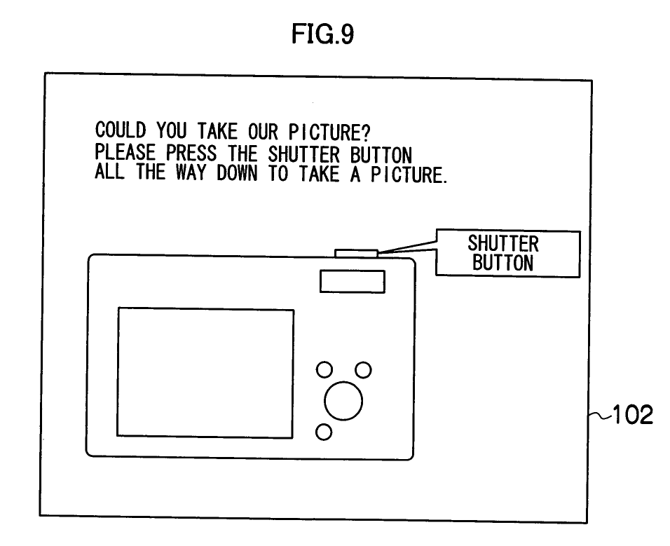

FIG. 9 is a display example of a help screen, and shows an explanation, stating that the release button 104 is positioned on the upper right portion of the camera 100, and that a pressing of the release button 104 completes an image pickup. A person who asks an image pickup does not have to explain the operation verbally, but only gives an advice to see the LCD 102 to the asked person. The photographer correctly and easily understands what to do for an image pickup by seeing the help screen, and smoothly starts an image pickup.

At S32, if a button such as an “Omit Explanation” on the GUI is pressed, the process may omit S33, and directly goes to S34.

### Fifth Embodiment

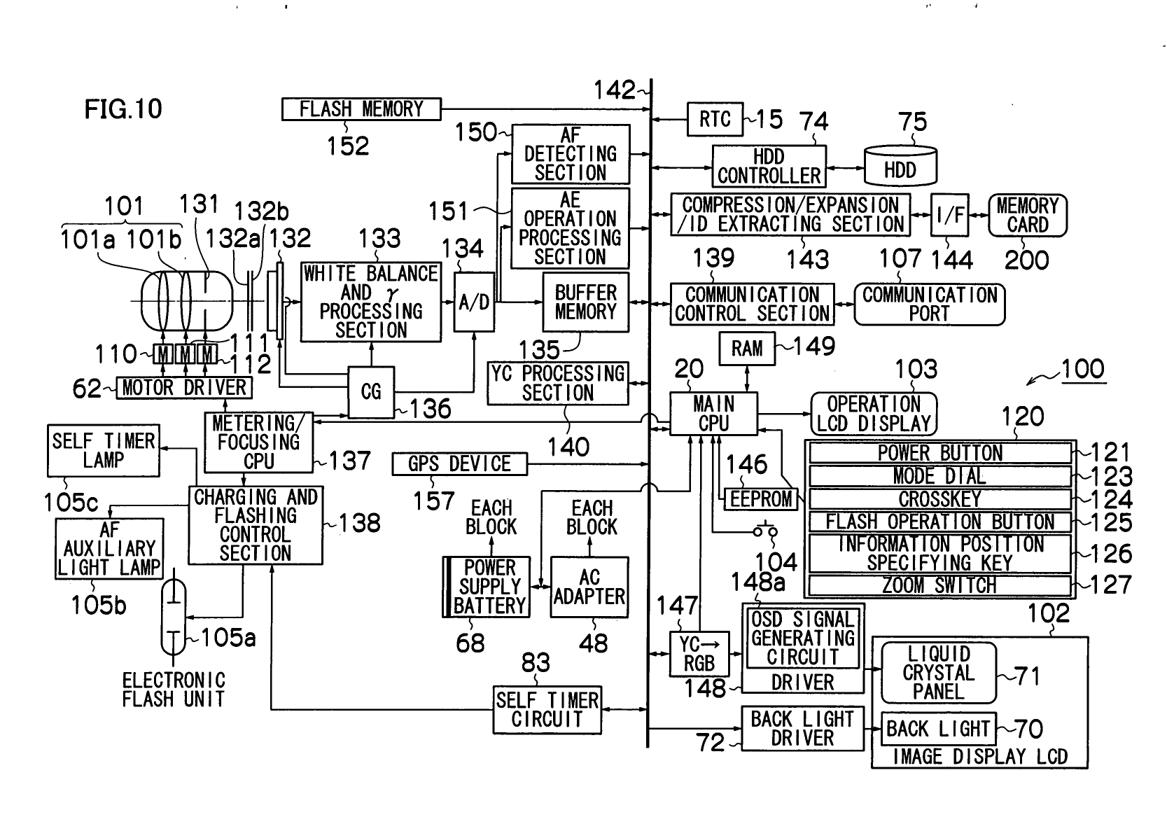

FIG. 10 is a block diagram showing a camera 100 according to a fifth embodiment. The camera 100 includes a GPS (Global Positioning System) device 157. The GPS device 157 receives radio waves emitted from a plurality of GPS satellites which orbit above the earth, at a built-in antenna thereof. The GPS device 157 obtains current position information by calculating the differences among the periods of time which is necessary from the emission to the arrival at the GPS device 157 with respect to the radio wave from each satellite.

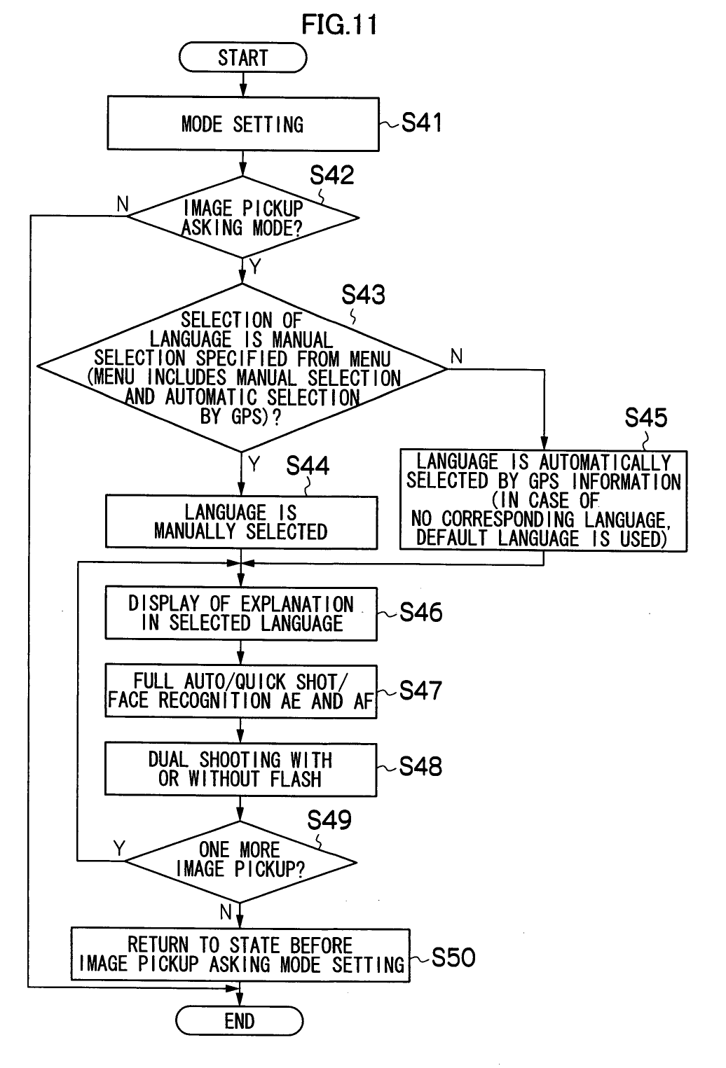

FIG. 11 is a flowchart showing a flow of an image pickup process according to a fifth embodiment.

S41, S42, and S47 to S50 are similar to S31, S32, S34 to S37, respectively.

At S43, the CPU 20 commands the OSD signal generating circuit 148a to generate a video signal of a “Language Selection” menu. The OSD signal generating circuit 148a, in response to the command from the CPU 20, generates a video signal of the “Language Selection” menu, and sends it to the LCD 102.

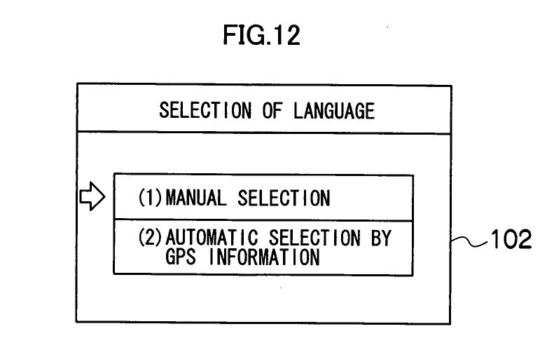

FIG. 12 is an example of the “Language Selection” menu displayed on the LCD 102. The menu includes a “Manual Selection” item and an “Automatic Selection from GPS information” item, and one of the items can be selected by using the crosskey 124 for example.

The CPU 20 determines which one of the “Manual Selection” item or the “Automatic Selection from GPS information” item is selected. When the “Manual Selection” is selected, the process goes to S44, and when the “Automatic Selection from GPS information” is selected, the process goes to S45.

At S44, the CPU 20 commands the OSD signal generating circuit 148a to generate a video signal of a “Manual Language Selection” menu. The OSD signal generating circuit 148a, in response to the command from the CPU 20, generates a video signal of the “Manual Language Selection” menu, and sends it to the LCD 102.

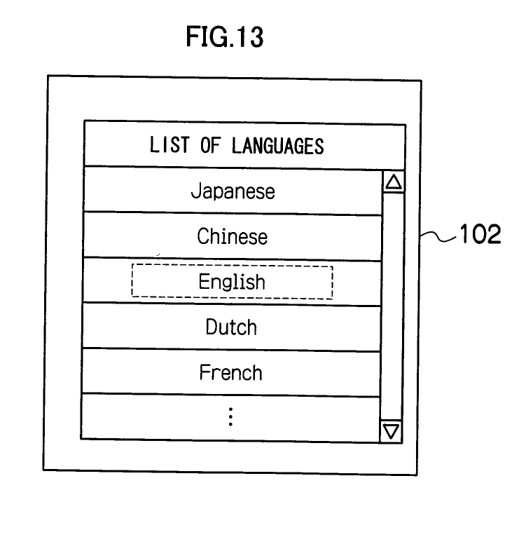

FIG. 13 is a view showing an example of a “Manual Language Selection” menu displayed on the LCD 102. In the menu, languages in various countries such as Japanese and Chinese which are stored in the EEPROM 146 in advance are displayed as a list. A user or photographer can select one of the languages, by operating the crosskey 124 or the information position specifying key 126 for example.

The CPU 20 sets the language selected from the “Manual Language Selection” menu as a language to be used in a help screen (desired language).

At S45, the CPU 20 acquires a current position by using the GPS device 157. Then, with reference to a language table stored in the EEPROM 146 in advance for defining a language (local language) which is used in the country or region corresponding to a current position, the CPU 20 sets a local language corresponding to the current position which is acquired by the GPS device 157 as a desired language.

If a local language corresponding to a current position is not stored in the EEPROM 146, the CPU 20 sets a default language (for example, English) as a desired language. If there is a plurality of local languages corresponding to a current position, the CPU 20 causes the local languages to be displayed in the “Manual Language Selection” menu, so that a user selects a certain local language from the displayed languages to set the selected local language as a desired language. When there is a plurality of local languages, a user sometimes does not know which one he/she should select. In this case, in response to a pressing of a “Local Language Is Unknown” button for example, a standard language corresponding to a current position (for example, Mandarin for a current position in China) may be set as a desired language.

At S46, the CPU 20 commands the OSD signal generating circuit 148a to generate a help screen described in the desired language which is set at S44 or S45. The OSD signal generating circuit 148a, in response to the command from the CPU 20, generates a video signal of a help screen described in the set desired language, and sends it to the LCD 102.

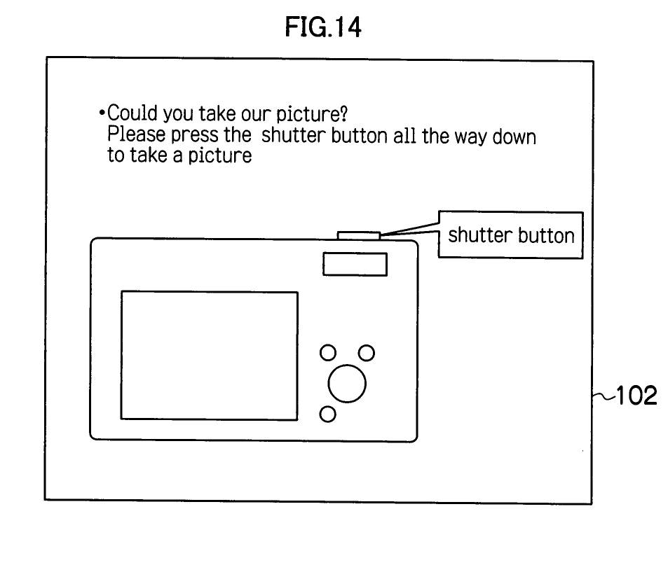

FIG. 14 is a view showing an example of a help screen in which a desired language is English.

In this way, a user can operate the crosskey 124 for example in the “Manual Selection” and “Manual Language Selection” to display a help screen which is described in the language the user desires, and show the help screen to a photographer to make him/her understand an operation procedure.

Although not shown, the “You Can Ask Image Pickup” button or the “One More Image Pickup?” button may be preferably described in a desired language.

When a user wants to omit the language selection, the user may select the “Automatic Selection from GPS information” item to cause a help screen to be displayed in a local language corresponding to a current position of the camera 100. This allows an explanation of the operation of the camera 100 to be displayed in a language which a photographer can understand even if the person who asks an image pickup and the photographer speak different languages, and a user who is traveling abroad can lightly ask local people to pickup an image.

What is claimed is:

1. An image pickup apparatus, comprising:
an image pickup element for receiving an incident light through an image pickup lens from an object and continuously converting the light into an image pickup signal to output;
an image data converting section for converting the image pickup signal output from the image pickup element into an image data to output;
a record indicating section for inputting a record indication of the image data;
an exposure controlling section for controlling an exposure of the image pickup element in response to an acceptance of an input of the record indication at the record indicating section;
a recording section for recording the image data of the image pickup signal output from the image pickup element in response to the exposure control by the exposure controlling section;
a display section for displaying at least the image data recorded in the recording section;
an image pickup asking section for accepting an input of information that a user asks a person to pickup an image;
an image pickup asking mode setting section for setting an image pickup asking mode which is an appropriate operation mode for picking up an image by the person in response to the input of information that the user asks the person to pickup an image at the image pickup asking section; and
an image pickup controlling section for immediately performing an automatic exposure control and automatic focusing control, in response to the acceptance of an input of the record indication at the record indicating section when the image pickup asking mode setting section sets the image pickup asking mode, and controlling the recording section to record the image data.

2. The image pickup apparatus according to claim 1, wherein
the exposure controlling section controls the exposure of the image pickup element at least two times in series in response to a single record indication to the record indicating section,
and the apparatus further comprises:
an amplifier for amplifying the image pickup signal from the image pickup element by an amplification factor which can be set as desired to output to the image data converting section;
a flashing section for flashing a light for picking up an image;
a flashing control section for controlling to switch the flashing of the flashing section between a non-flashing state and a flashing state, in accordance with the serial exposure controls of the image pickup element by the exposure controlling section in response to the single record indication to the record indicating section, and
wherein the image pickup controlling section controls the recording section to record the image data of the image pickup signal output from the image pickup element after the amplification factor of the amplifier is set to be a predetermined higher amplification factor in accordance with the non-flashing state, and the image data of the image pickup signal output from the image pickup element after the amplification factor of the amplifier is set to be a predetermined lower amplification factor in accordance with the flashing state.

3. The image pickup apparatus according to claim 1, further comprising a face detecting section for detecting a face area of the object based on the image data output from the image data converting section,
wherein when the image pickup asking mode setting section sets the image pickup asking mode, the image pickup controlling section immediately performs the automatic exposure control and automatic focusing control for the face area detected by the face detecting section.

4. The image pickup apparatus according to claim 2, further comprising a face detecting section for detecting a face area of the object based on the image data output from the image data converting section,
wherein when the image pickup asking mode setting section sets the image pickup asking mode, the image pickup controlling section immediately performs the automatic exposure control and automatic focusing control for the face area detected by the face detecting section.

5. The image pickup apparatus according to claim 1, further comprising a video image generating section for generating a video signal of a help screen which describes an operation procedure to pickup an image and outputting the video signal to the display section,
wherein when the image pickup asking mode setting section sets the image pickup asking mode, the image pickup controlling section controls the video image generating section to generate the help screen.

6. The image pickup apparatus according to claim 4, further comprising a video image generating section for generating a video signal of a help screen which describes an operation procedure to pickup an image and outputting the video signal to the display section,
wherein when the image pickup asking mode setting section sets the image pickup asking mode, the image pickup controlling section controls the video image generating section to generate the help screen.

7. The image pickup apparatus according to claim 5, further comprising a language selecting section for selecting a desired language from the help screen,
wherein the image pickup controlling section controls the video image generating section to generate the help screen which describes the operation procedure for image pickup in the desired language selected in the language selecting section.

8. The image pickup apparatus according to claim 6, further comprising a language selecting section for selecting a desired language from the help screen,
wherein the image pickup controlling section controls the video image generating section to generate the help screen which describes the operation procedure for image pickup in the desired language selected in the language selecting section.

9. The image pickup apparatus according to claim 7, wherein the language selecting section selects the desired language in response to an input operation using an external device.

10. The image pickup apparatus according to claim 8, wherein the language selecting section selects the desired language in response to an input operation using an external device.

11. The image pickup apparatus according to claim 7, further comprising a position acquiring section for receiving information on a current position to acquire the current position,
wherein the language selecting section selects a language corresponding to the current position acquired by the position acquiring section as the desired language.

12. The image pickup apparatus according to claim 8, further comprising a position acquiring section for receiving information on a current position to acquire the current position,
wherein the language selecting section selects a language corresponding to the current position acquired by the position acquiring section as the desired language.

13. The image pickup apparatus according to claim 9, further comprising a position acquiring section for receiving information on a current position to acquire the current position,
wherein the language selecting section selects a language corresponding to the current position acquired by the position acquiring section as the desired language.

14. The image pickup apparatus according to claim 10, further comprising a position acquiring section for receiving information on a current position to acquire the current position,
wherein the language selecting section selects a language corresponding to the current position acquired by the position acquiring section as the desired language.

15. The image pickup apparatus according to claim 1, wherein
the image pickup asking section accepts an input of a completion of the request for image pickup,
the image pickup asking mode setting section cancels the image pickup asking mode in response to the input of the completion of the request for image pickup to the image pickup asking section, and
the image pickup controlling section causes the image pickup apparatus to return to the operating state before the image pickup asking mode setting section sets the image pickup asking mode, when the image pickup asking mode setting section cancels the image pickup asking mode.

16. The image pickup apparatus according to claim 2, wherein
the image pickup asking section accepts an input of a completion of the request for image pickup,
the image pickup asking mode setting section cancels the image pickup asking mode in response to the input of the completion of the request for image pickup to the image pickup asking section, and
the image pickup controlling section causes the image pickup apparatus to return to the operating state before the image pickup asking mode setting section sets the image pickup asking mode, when the image pickup asking mode setting section cancels the image pickup asking mode.

17. The image pickup apparatus according to claim 4, wherein
the image pickup asking section accepts an input of a completion of the request for image pickup,
the image pickup asking mode setting section cancels the image pickup asking mode in response to the input of the completion of the request for image pickup to the image pickup asking section, and
the image pickup controlling section causes the image pickup apparatus to return to the operating state before the image pickup asking mode setting section sets the image pickup asking mode, when the image pickup asking mode setting section cancels the image pickup asking mode.

18. The image pickup apparatus according to claim 6, wherein
the image pickup asking section accepts an input of a completion of the request for image pickup,
the image pickup asking mode setting section cancels the image pickup asking mode in response to the input of the completion of the request for image pickup to the image pickup asking section, and
the image pickup controlling section causes the image pickup apparatus to return to the operating state before the image pickup asking mode setting section sets the image pickup asking mode, when the image pickup asking mode setting section cancels the image pickup asking mode.

19. The image pickup apparatus according to claim 8, wherein
the image pickup asking section accepts an input of a completion of the request for image pickup,
the image pickup asking mode setting section cancels the image pickup asking mode in response to the input of the completion of the request for image pickup to the image pickup asking section, and
the image pickup controlling section causes the image pickup apparatus to return to the operating state before the image pickup asking mode setting section sets the image pickup asking mode, when the image pickup asking mode setting section cancels the image pickup asking mode.

20. The image pickup apparatus according to claim 10, wherein
the image pickup asking section accepts an input of a completion of the request for image pickup,
the image pickup asking mode setting section cancels the image pickup asking mode in response to the input of the completion of the request for image pickup to the image pickup asking section, and
the image pickup controlling section causes the image pickup apparatus to return to the operating state before the image pickup asking mode setting section sets the image pickup asking mode, when the image pickup asking mode setting section cancels the image pickup asking mode.

21. The image pickup apparatus according to claim 14, wherein
the image pickup asking section accepts an input of a completion of the request for image pickup,
the image pickup asking mode setting section cancels the image pickup asking mode in response to the input of the completion of the request for image pickup to the image pickup asking section, and
the image pickup controlling section causes the image pickup apparatus to return to the operating state before the image pickup asking mode setting section sets the image pickup asking mode, when the image pickup asking mode setting section cancels the image pickup asking mode.

22. An image pickup control method which is used for an image pickup apparatus comprising: an image pickup element for receiving an incident light through an image pickup lens from an object and continuously converting the light into an image pickup signal to output; an image data converting section for converting the image pickup signal output from the image pickup element into an image data to output; a record indicating section for inputting a record indication of the image data; an exposure controlling section for controlling an exposure of the image pickup element in response to an acceptance of an input of the record indication at the record indicating section; a recording section for recording the image data of the image pickup signal output from the image pickup element in response to the exposure control by the exposure controlling section; and a display section for displaying at least the image data recorded in the recording section, the method comprising the steps of:
accepting an input of information that a user asks a person to pickup an image;
setting an image pickup asking mode which is an appropriate operation mode for picking up an image by the person, in response to the input of information that the user asks the person to pick up an image; and
immediately performing an automatic exposure control and automatic focusing control, and controlling the recording section to record the image data, when the image pickup asking mode is set, in response to the acceptance of an input of the record indication at the record indicating section.
